(19) United States
(12) Patent Application Publication
(10) Pub. No.: US 2023/0267532 A1
(43) Pub. Date: Aug. 24, 2023

(54) SHOPPING MOBILE APPLICATION

(71) Applicant: DeJohn Louder, Houston, TX (US)

(72) Inventor: DeJohn Louder, Houston, TX (US)

(21) Appl. No.: 18/114,222

(22) Filed: Feb. 24, 2023

Related U.S. Application Data
(60) Provisional application No. 63/313,281, filed on Feb. 24, 2022.

(51) Int. Cl. G06Q 30/0601

(52) U.S. Cl. CPC G06Q 30/0643; G06Q 30/0633

(57) ABSTRACT

Implementations of a shopping mobile application for a portable computing device, such as a smart phone, configured to use for purchasing merchandise, such as clothes, shoes, accessories, and fragrances, and in some implementations, a corresponding software application for a computing device, such as a desktop or laptop computer.

### CROSS REFERENCE TO RELATED APPLICATION

This application claims the benefit of U.S. patent application Ser. No. 63/313,281, which was filed on Feb. 24, 2022, and is incorporated herein by reference in its entirety.

### TECHNICAL FIELD

This disclosure relates to implementations of a shopping mobile application.

### BACKGROUND

In a typical brick and mortar setting, a retail customer may shop with others to get feedback on merchandise and may listen to music playing in the retail store while shopping. Many of these experiences are not available while shopping online.

### BRIEF DESCRIPTION OF THE DRAWINGS

FIG. 1 illustrates an implementation of an example environment of the shopping mobile application according to the present disclosure.

FIG. 2 illustrates an example computer system, which may be used with implementations of the present disclosure.

FIGS. 3A-3N illustrate implementations of example user interfaces of the shopping mobile application according to the present disclosure.

### DETAILED DESCRIPTION

Implementations of a shopping mobile application are provided. In some implementations, the shopping mobile application comprises a mobile application for a portable computing device, such as a smart phone or similar device (e.g., an iPhone® or iPad®). In some implementations, the shopping mobile application may comprise a corresponding software application for a computing device, such as a desktop or laptop computer. Therefore, the shopping mobile application may be described or otherwise referred to collectively herein the present disclosure as an “application” or “software” for a “computing device”.

In some implementations, the shopping mobile application can be used for purchasing merchandise. For example, in some implementations, the shopping mobile application can be used for purchasing merchandise such as clothes, shoes, accessories, and fragrances.

Implementations of the shopping mobile application are described herein by way of examples with respect to clothes, however it should be understood that such descriptions, examples, etc. apply to any other suitable merchandise, such as shoes, accessories, fragrances, or any other merchandise, which will be understood by one skilled in the art.

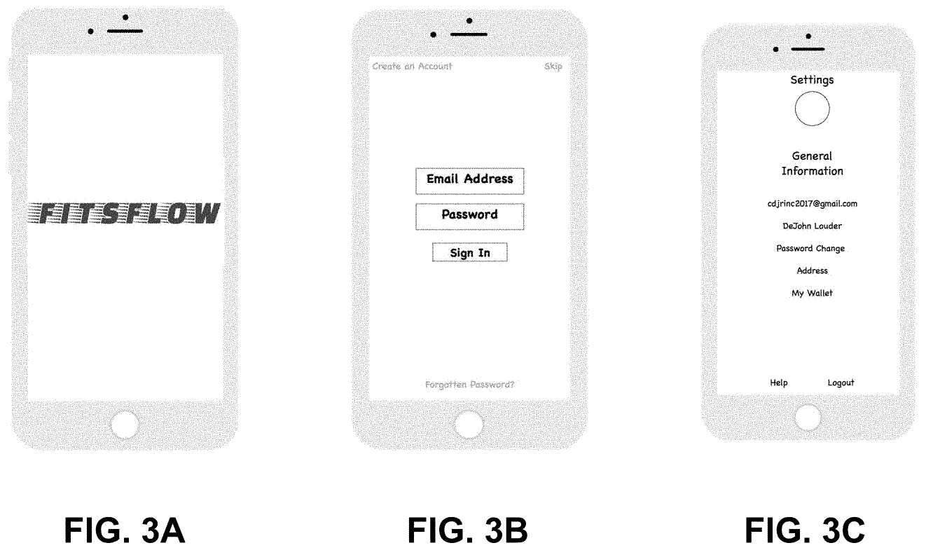

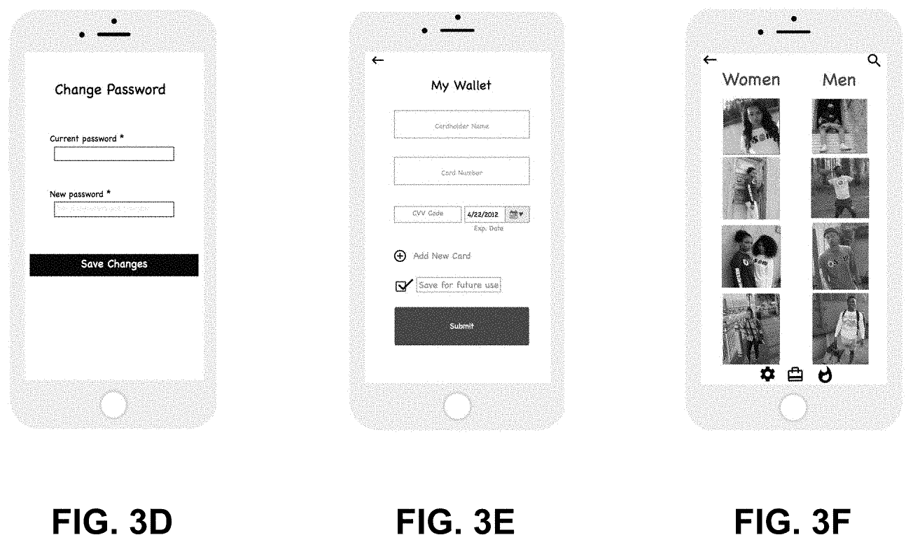

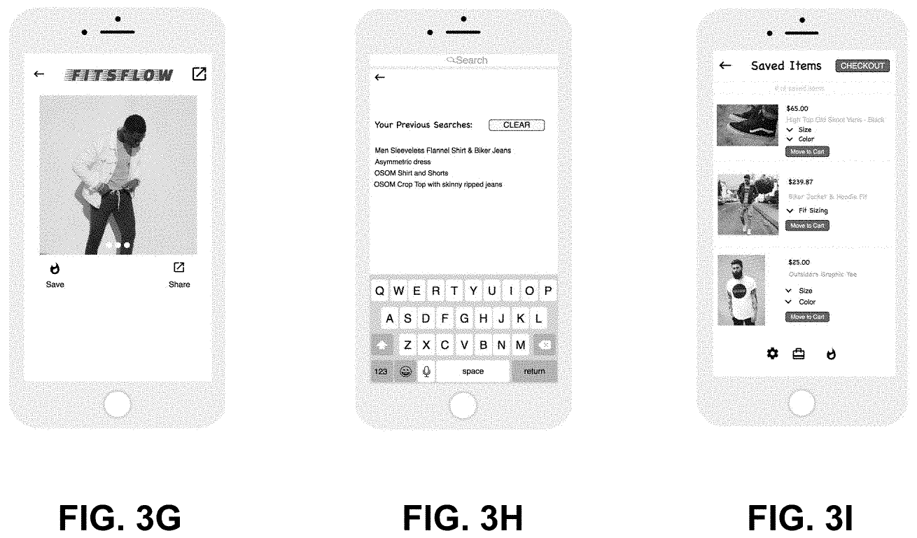

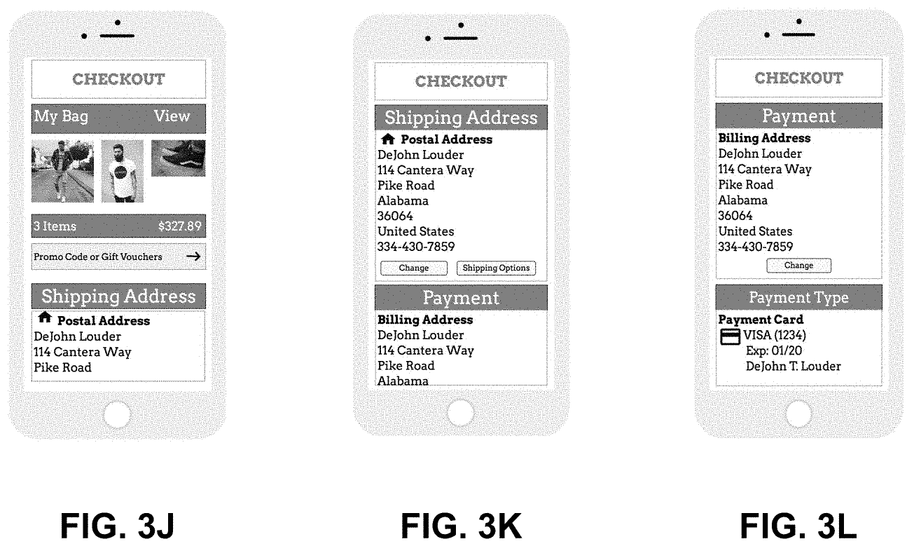

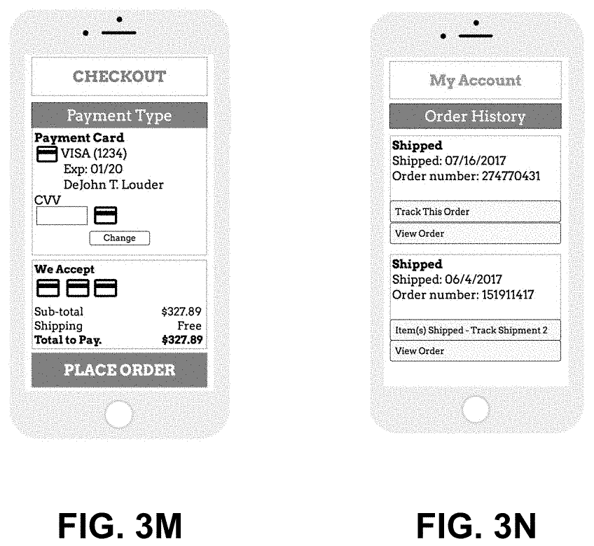

In some implementations, the shopping mobile application is configured to allow a user to open, login, and manage the use of the shopping mobile application. For example, as shown in FIGS. 3A and 3B, in some implementations, one or more of the user interfaces of the shopping mobile application are configured to allow a user to open and login to the shopping mobile application using a username, such as an email address, and a password.

As shown in FIGS. 3C and 3D, in some implementations, one or more of the user interfaces of the shopping mobile application are configured to allow a user to review and manage login and user information, such as to change the password and modify user settings for the shopping mobile application.

In some implementations, the shopping mobile application is configured to display items in a grid format. For example, FIG. 3F illustrates an example of a user interface of the shopping mobile application where pictures are displayed in a grid format. In some implementations, the shopping mobile application is configured to display items in any other suitable format.

In some implementations, the shopping mobile application is configured to display pictures showing models wearing clothes (or other merchandise) that are for sale. In some implementations, the clothes (or other merchandise) may be from different brands. For example, as shown in FIGS. 3F and 3G, in some implementations, one or more of the user interfaces of the shopping mobile application are configured to display pictures showing models wearing clothes for sale from different brands.

In some implementations, the shopping mobile application is configured such that a user can search by brand for clothes (or other merchandise) to purchase.

In some implementations, the shopping mobile application is configured such that a user can select clothes (or other merchandise) to purchase from pictures showing models wearing the clothes. For example, in some implementations, one or more of the user interfaces of the shopping mobile application (such as shown in FIGS. 3F and 3G) are configured to allow a user to click or otherwise select clothes worn by a model displayed in pictures to purchase.

In some implementations, the one or more user interfaces (such as shown in FIGS. 3F and 3G) are further configured such that the selected clothes (or other merchandise) worn by a model displayed in a picture are added to a shopping cart of the shopping mobile application for purchase. For example, FIG. 3J illustrates an example shopping cart user interface of the shopping mobile application to which the selected clothes can be added and displayed for purchase.

In some implementations, the shopping mobile application is configured to play music. For example, in some implementations, the shopping mobile application is configured to play music in the background while a user scrolls through pictures for purchasing clothes (or other merchandise) using the shopping mobile application. In some implementations, the shopping mobile application is configured to thereby provide a shopping experience similar to the experience a user may have if the user went to a brick-and-mortar store. In some implementations, a user can indicate musical preferences in the settings of the shopping mobile application (such as the type, style, etc. of music). In some implementations, the shopping mobile application can receive a playlist or musical preferences from other applications.

In some implementations, the shopping mobile application is configured such that a user can checkout to purchase and receive clothes (or other merchandise) selected using the shopping mobile application. For example, as shown in FIGS. 3E and 3K-3M, in some implementations, one or more of the user interfaces of the shopping mobile application are configured such that a user can submit payment and address information to purchase and receive selected merchandise.

In some implementations, the shopping mobile application is configured to track interactions of a user on the shopping mobile application such as items (i.e., clothes or other merchandise) saved for purchase later, items previously searched and/or viewed, items previously purchased, items shared with friends or others, etc. For example, as shown in FIG. 3I, in some implementations, one or more of the user interfaces of the shopping mobile application are configured to store, retrieve, and display saved items.

In some implementations, the shopping mobile application is configured such that a user can share items for sale on the shopping mobile application (i.e., clothes or other merchandise) with friends, family, etc. For example, in some implementations, the shopping mobile application is configured to provide a direct messaging feature from one user to other users, such as users who have created a profile, to allow such sharing. In some implementation, the shopping mobile application is configured such that the user can received feedback regarding the shared item from the other user.

In some implementations, the shopping mobile application is configured to track data analytics of the sharing interactions such as the direct messaging.

As shown in FIG. 3H, in some implementations, one or more of the user interfaces of the shopping mobile application are configured to store, retrieve, and display previously searched items. As shown in FIG. 3N, in some implementations, one or more of the user interfaces of the shopping mobile application are configured to store, retrieve, and display an order history (i.e., items previously purchased).

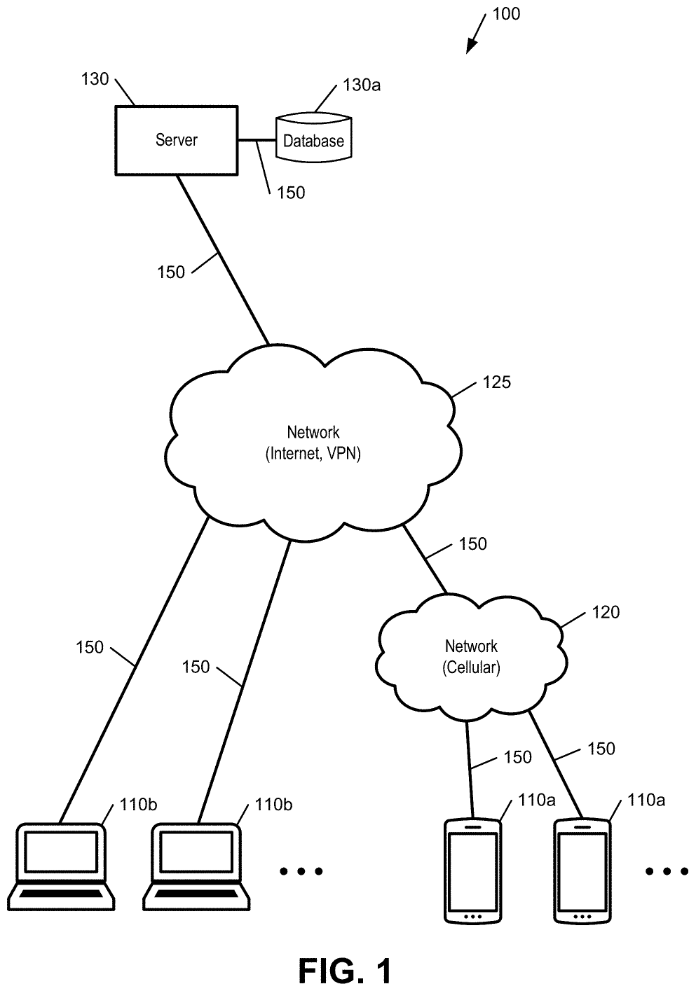

FIG. 1 illustrates an implementation of an example environment 100 of a shopping mobile application according to the present disclosure.

As shown in FIG. 1, in some implementations, the environment 100 may include one or more client devices 110a and 110b (collectively “client devices 110”), wireless cellular network 120, network 125, and servers 130. In some implementations, the environment 100 may also include one or more data storages 130a linked to the servers 130.

As described above, in some implementations, a computing device (“client device”) 110 may be used to allow a user to shop for merchandise, such as clothes, shoes, accessories, fragrances, and any other merchandise.

As described above, in some implementations, the client device 110 may be used to open, login, and manage the use of the shopping mobile application. In some implementations, the client device 110 may be used to display items.

As described above, in some implementations, the client device 110 may be used to display pictures showing models wearing clothes or other merchandise that is for sale. In some implementations, the client device 110 may be used by a user to select clothes (or other merchandise) to purchase from pictures showing models wearing the clothes.

As described above, in some implementations, the client device 110 may be used to play music in the background while a user scrolls through pictures for purchasing clothes or other merchandise. In some implementations, the client device 110 may be used to help mimic a clothes (or other merchandise) shopping experience that a user may have if they user went to a brick-and-mortar store.

As described above, in some implementations, the client device 110 may be used by a user to checkout in order to purchase and receive clothes or other merchandise selected using the shopping mobile application.

As described above, in some implementations, the client device 110 may be used to track interactions of a user such as items (i.e., clothes or other merchandise) saved for purchase later, items previously searched and/or viewed, items previously purchased, items shared with friends or others, etc.

As described above, in some implementations, the client device 110 may be used by a user to share items (i.e., clothes or other merchandise) with friends, family, etc. In some implementations, the client device 110 may be used for direct messaging by a user to other users, such as users who have created a profile to allow such sharing.

As described above, in some implementations, the client device 110 may be used to track data analytics of the sharing interactions such as the direct messaging.

As described above, in some implementations, the client device 110 may be used to display opening and login user interfaces such as shown in FIGS. 3A and 3B. In some implementations, the client device 110 may be used to display login and settings management user interfaces such as shown in FIGS. 3C and 3D.

As described above, in some implementations, the client device 110 may be used to display grid format picture user interfaces such as shown in FIG. 3F.

As described above, in some implementations, the client device 110 may be used to display clothes (or other merchandise) model picture user interfaces such as shown in FIGS. 3F and 3G. In some implementations, the client device 110 may be used to display clothes (or other merchandise) selection user interfaces such as shown in FIGS. 3F and 3G.

As described above, in some implementations, the client device 110 may be used to display shopping cart user interfaces such as shown in FIG. 3J.

As described above, in some implementations, the client device 110 may be used to display address and payment information user interfaces such as shown in FIGS. 3E and 3K-3M.

As described above, in some implementations, the client device 110 may be used to display saved items user interfaces such as shown in FIG. 3I.

As described above, in some implementations, the client device 110 may be used to display previously searched items user interfaces such as shown in FIG. 3H.

As described above, in some implementations, the client device 110 may be used to display order history (i.e., previously purchased items) user interfaces such as shown in FIG. 3N.

In some implementations, the server 130 may be used to transmit over a network pictures of available clothes or other merchandise for purchase to the client device 110.

In some implementations, the server 130 may be used to receive clothes (or other merchandise) order and purchase information transmitted over a network from the client device 110.

Client devices 110a and 110b (collectively “client devices 110”) are depicted as a mobile phone 110a and a desktop computer 110b, respectively, but client devices 110 may comprise any type of computing device, such as a desktop computer system, a laptop, cellular phone, a smart device, a mobile telephone, a tablet-style computer, or any other device capable of wireless or wired communication. In some implementations, client devices 110 are configured to interact with the server 130 via an application, such as a web browser or a native application, residing on the client device 110.

In some implementations, the client devices 110 include hardware, software, or embedded logic components or a combination of two or more such components and is configured to carry out the appropriate functions implemented or supported by the client devices 110.

In some implementations, the client devices 110 may include one or more processors, one or more memories, one or more displays, one or more interfaces, one or more components capable of inputting data, one or more components capable of outputting data, one or more components capable of communicating with any other component of the environment 100 or any other component suitable for a particular purpose.

In some implementations, the client devices 110 are configured to access networks 120 and/or 125. In some implementations, the client devices 110 are configured to communicate with servers 130.

In some implementations, the client devices 110 can connect to the network 125 through a wireless cellular network 120, such as GPRS-based and CDMA-based wireless networks, as well as 802.16 WiMax and long-range wireless data networks.

In some implementations, components of the environment 100 may communicate with any other component of the environment 100 over network 125. Network 125 may be any suitable network. In some implementations, for example, one or more portions of network 125 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 125, or a combination of two or more of the foregoing.

In some embodiments, components of the environment 100 may be configured to communicate over links 150. Links 150 may connect components of the environment 100 to networks 120, 125 or to each other. In some implementations, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 150. Links 150 may not be the same throughout the environment 100.

In some implementations, the server devices 130 may include a processor, memory, user accounts, and one or more modules to perform various functions such as those described above.

In some implementations, each server 130 may be a unitary server or may be a distributed server spanning multiple computers or multiple datacenters. Servers 130 may be of various types, such as, for example and without limitation, web server, file server, application server, exchange server, database server, or proxy server. In some implementations, each server 130 may include hardware, software, or embedded logic components or a combination of two or more such components for carrying out the appropriate functionalities implemented or supported by server 130. For example, a web server is generally capable of hosting websites containing web pages or particular elements of web pages. More specifically, a web server may host HTML files or other file types, or may dynamically create or constitute files upon a request, and communicate them to clients 110 in response to HTTP or other requests from clients 110. A database server is generally capable of providing an interface for managing data stored in one or more data stores.

In some implementations, one or more data storages 130a may be communicatively linked to one or more servers 130, respectively, via one or more links 150. In some implementations, data storages 130a may be used to store various types of information. For example, in some implementations, the data storages 130a may be used to store pictures of merchandise that can be received and displayed by the client 110. In some implementations, the data storages 130a may be used to store user login and settings information for use of the shopping mobile application on the client 110.

In some implementations, the data storages 130a may be used to store selections of the pictures of merchandise that are added to the shopping cart for ordering and purchase using the client 110, such as saved items. In some implementations, the data storages 130a may be used to store searches (e.g., by brand) of pictures of merchandise using the client 110, such as previously searched items.

In some implementations, the data storages 130a may be used to store selections of the pictures of merchandise that are ordered and purchased using the client 110, such as an order history or previously purchased items. In some implementations, the data storages 130a may be used to store pictures of merchandise that are shared with other users using the client 110, such as shared items.

In some implementations, the data storages 130a may be used to store payment and address information for the ordering and purchase of merchandise using the client 110. In some implementations, the data storages 130a may be used to store any other suitable information associated with the use of the shopping mobile application.

In some implementations, the information stored in data storages 130a may be organized according to specific data structures. In particular embodiment, each data storage 130a may be a relational database. Particular embodiments may provide interfaces that enable servers 130 or clients 110 to manage, e.g., retrieve, modify, add, or delete, the information stored in data storage 130a.

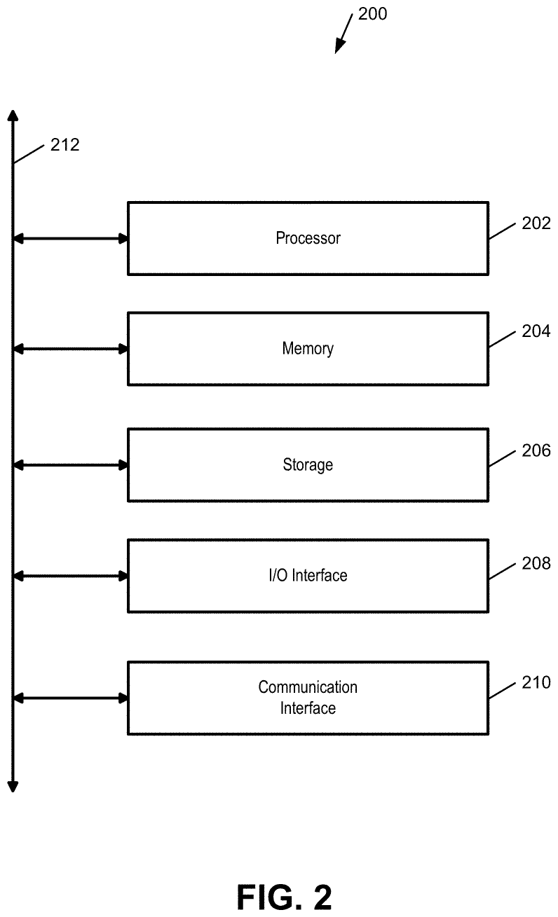

FIG. 2 illustrates an example computer system 200, which may be used with some implementations of the present invention. This disclosure contemplates any suitable number of computer systems 200.

This disclosure contemplates computer system 200 taking any suitable physical form. In some implementations, as an example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these.

In some implementations, where appropriate, computer system 200 may include one or more computer systems 200; be unitary or distributed; span multiple locations; span multiple machines; or reside in a cloud, which may include one or more cloud components in one or more networks.

In some implementations, where appropriate, one or more computer systems 200 may perform without substantial spatial or temporal limitation one or more steps of one or more methods described or illustrated herein. In some implementations, as an example and not by way of limitation, one or more computer systems 200 may perform in real time or in batch mode one or more steps of one or more methods described or illustrated herein. In some implementations, one or more computer systems 200 may perform at different times or at different locations one or more steps of one or more methods described or illustrated herein, where appropriate.

In some implementations, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In some implementations, processor 202 includes hardware for executing instructions, such as those making up a computer program. In some implementations, as an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206.

In some implementations, processor 202 may include one or more internal caches for data, instructions, or addresses. The present disclosure contemplates processor 202 including any suitable number of any suitable internal caches, where appropriate. In some implementations, as an example and not by way of limitation, processor 202 may include one or more instruction caches, one or more data caches, and one or more translation look-aside buffers (TLBs).

In some implementations, instructions in the instruction caches may be copies of instructions in memory 204 or storage 206, and the instruction caches may speed up retrieval of those instructions by processor 202.

In some implementations, data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data.

In some implementations, the data caches may speed up read or write operations by processor 202. In some implementations, the TLBs may speed up virtual-address translation for processor 202.

In some implementations, processor 202 may include one or more internal registers for data, instructions, or addresses. The present disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In some implementations, memory 204 includes main memory for storing instructions for processor 202 to execute or data for processor 202 to operate on. In some implementations, as an example and not by way of limitation, computer system 200 may load instructions from storage 206 or another source (such as, for example, another computer system 200) to memory 204.

In some implementations, processor 202 may then load the instructions from memory 204 to an internal register or internal cache. In some implementations, to execute the instructions, processor 202 may retrieve the instructions from the internal register or internal cache and decode them.

In some implementations, during or after execution of the instructions, processor 202 may write one or more results (which may be intermediate or final results) to the internal register or internal cache. In some implementations, processor 202 may then write one or more of those results to memory 204.

In some implementations, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere).

In some implementations, one or more memory buses (which may each include an address bus and a data bus) may couple processor 202 to memory 204. In some implementations, bus 212 may include one or more memory buses, as described below.

In some implementations, one or more memory management units (MMUs) reside between processor 202 and memory 204 and facilitate accesses to memory 204 requested by processor 202.

In some implementations, memory 204 includes random access memory (RAM). In some implementations, this RAM may be volatile memory, where appropriate.

In some implementations, where appropriate, this RAM may be dynamic RAM (DRAM) or static RAM (SRAM). Moreover, in some implementations, where appropriate, this RAM may be single-ported or multi-ported RAM. The present disclosure contemplates any suitable RAM.

In some implementations, memory 204 may include one or more memories 204, where appropriate. Although this disclosure describes and illustrates particular memory, this disclosure contemplates any suitable memory.

In some implementations, storage 206 includes mass storage for data or instructions. In some implementations, as an example and not by way of limitation, storage 206 may include an HDD, a floppy disk drive, flash memory, an optical disc, a magneto-optical disc, magnetic tape, or a Universal Serial Bus (USB) drive or a combination of two or more of these.

In some implementations, storage 206 may include removable or non-removable (or fixed) media, where appropriate. In some implementations, storage 206 may be internal or external to computer system 200, where appropriate. In some implementations, storage 206 is non-volatile, solid-state memory.

In some implementations, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form.

In some implementations, storage 206 may include one or more storage control units facilitating communication between processor 202 and storage 206, where appropriate. In some implementations, where appropriate, storage 206 may include one or more storages 206. Although this disclosure describes and illustrates particular storage, this disclosure contemplates any suitable storage.

In some implementations, I/O interface 208 includes hardware, software, or both providing one or more interfaces for communication between computer system 200 and one or more I/O devices. In some implementations, computer system 200 may include one or more of these I/O devices, where appropriate.

In some implementations, one or more of these I/O devices may enable communication between a person and computer system 200. In some implementations, as an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

In some implementations, an I/O device may include one or more sensors. This disclosure contemplates any suitable I/O devices and any suitable I/O interfaces 208 for them.

In some implementations, where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In some implementations, communication interface 210 includes hardware, software, or both providing one or more interfaces for communication (such as, for example, packet-based communication) between computer system 200 and one or more other computer systems 200 or one or more networks.

In some implementations, as an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it.

In some implementations, as an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these.

In some implementations, one or more portions of one or more of these networks may be wired or wireless. In some implementations, as an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some implementations, computer system 200 may include any suitable communication interface 210 for any of these networks, where appropriate. In some implementations, communication interface 210 may include one or more communication interfaces 210, where appropriate. Although this disclosure describes and illustrates a particular communication interface, this disclosure contemplates any suitable communication interface.

In some implementations, bus 212 includes hardware, software, or both coupling components of computer system 200 to each other. In some implementations, as an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these.

In some implementations, bus 212 may include one or more buses 212, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. In some implementations, as an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate.

Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some implementations, a computer-readable storage medium implements one or more portions of processor 202 (such as, for example, one or more internal registers or caches), one or more portions of memory 204, one or more portions of storage 206, or a combination of these, where appropriate.

In some implementations, a computer-readable storage medium implements RAM or ROM. In some implementations, a computer-readable storage medium implements volatile or persistent memory.

In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate.

In some implementations, software includes one or more application programming interfaces (APIs). This disclosure contemplates any suitable software written or otherwise expressed in any suitable programming language or combination of programming languages.

In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code).

In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, it will be apparent to one of ordinary skill in the art that the invention may be used with any electronic network service, even if it is not provided through a website.

Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

The figures, including photographs and drawings, comprised herewith may represent one or more implementations of the shopping mobile application.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A computer-implemented method for shopping, the method comprising:
receiving at a first computing device pictures transmitted over a network from a second computing device;
displaying the pictures on the first computing device wherein the pictures comprise non-selectable merchandise that is not for purchase and selectable merchandise for purchase;
playing music on the first computing device while displaying the pictures; and
receiving a selection of one of the selectable merchandise on the first computing device and adding the selection to a shopping cart for purchase.

2. The computer-implemented method for shopping of claim 1 wherein the selectable merchandise is clothing.

3. The computer-implemented method for shopping of claim 1 wherein the pictures are displayed on the first computing device in a grid format.

4. The computer-implemented method for shopping of claim 1 wherein the pictures displayed on the first computing device comprise models wearing the selectable merchandise.

5. The computer-implemented method for shopping of claim 1 further comprising sharing at least one of the pictures received on the first computing device with a third computing device over a network and receiving feedback from the third computing device over a network.

6. The computer-implemented method for shopping of claim 1 further comprising displaying a direct messaging interface for composing and sending a direct message over a network to a third computing device.

7. The computer-implemented method for shopping of claim 1 further comprising displaying a checkout interface for ordering and purchasing the merchandise added to the shopping cart on the first computing device.

8. A computer-implemented method for shopping, the method comprising:
receiving at a first computing device pictures transmitted over a network from a second computing device;
displaying the pictures on the first computing device wherein the pictures comprise non-selectable merchandise that is not for purchase and selectable merchandise for purchase and wherein the pictures are displayed in a grid format; and
receiving a selection of one of the selectable merchandise on the first computing device and adding the selection to a shopping cart for purchase.

9. The computer-implemented method for shopping of claim 8 further comprising playing music on the first computing device while displaying the pictures.

10. The computer-implemented method for shopping of claim 8 wherein the selectable merchandise is clothing.

11. The computer-implemented method for shopping of claim 8 wherein the pictures are of models wearing the selectable merchandise.

12. A computer-implemented method for shopping, the method comprising:
receiving at a first computing device pictures transmitted over a network from a second computing device;
displaying the pictures on the first computing device wherein the pictures comprise non-selectable merchandise that is not for purchase and selectable merchandise for purchase, wherein the pictures are displayed in a grid format, wherein the merchandise is clothing, and wherein the pictures comprise models wearing the selectable merchandise;
playing background music on the first computing device while displaying the pictures;
sharing at least one of the pictures received on the first computing device with a third computing device over a network and receiving feedback from the third computing device over the network; and
receiving a selection of one of the selectable merchandise on the first computing device and adding the selection to a shopping cart for purchase.
